(19) United States
(12) Patent Application Publication
(10) Pub. No.: US 2021/0271974 A1
(43) Pub. Date: Sep. 2, 2021

(54) ANNOTATION SYSTEM FOR A NEURAL NETWORK

(71) Applicant: XJERA LABS PTE. LTD., Singapore (SG)

(72) Inventors: Lu DING, Singapore (SG); JunWu ZHANG, Singapore (SG); XinQi CHU, Singapore (SG)

(21) Appl. No.: 17/258,459

(22) PCT Filed: Jun. 29, 2019
(86) PCT No.: PCT/SG2019/050324

§ 371 Date: Jan. 7, 2021

(30) Foreign Application Priority Data
Jul. 7, 2018 (SG) 10201805864P

(51) Int. Cl. G06N 3/08; G06N 3/04; G06N 3/10

(52) U.S. Cl. CPC G06N 3/08; G06F 40/30; G06N 3/10; G06N 3/04

(57) ABSTRACT

An annotation system for a neural network and a method thereof are disclosed in the present application. The annotation system comprises a memory and a processor operatively coupled to the memory. The memory is configured for storing instructions to cause the process to receive information comprising a first set of unlabeled instances from at least one source; set a learning target of the information; select a second set of unlabeled instances from the first set of unlabeled instances by executing a software algorithm; and annotate the second set of unlabeled instances for generating labeled data. The software algorithm increases an efficiency of annotation in training neural networks for deep-learning-based video analysis by combining semi-supervised learning and transfer learning via a data augmentation method. The software algorithm can increase the efficiency of annotation by reducing an amount of annotation by an order of one magnitude.

The present application claims a filing date of Singapore patent application Nr. 10201805864P as its priority date, which was filed with IPOS (Intellectual Property Office of Singapore) on 7 Jul. 2018, and has the title of Software Algorithm Combining Semi-Supervised Learning and Transfer Learning to Increase the Efficiency of Annotation. All relevant content and/or subject matter of the earlier priority patent application is hereby incorporated by reference wherever appropriate.

The present application relates to an annotation system for deep learning and/or a method thereof, particularly a field of annotation in video analytics. The annotation system comprises relevant device(s), method(s) and/or a combination of both device(s) as well as method(s) of the same.

Nowadays, huge amount of unlabeled data is generated daily, including texts, images, videos, sounds and signals. Manual annotation of the unlabeled data for deep learning is practically infeasible. Therefore, known neural network technologies are provided for automatic annotation. For example, some machine learning based video analytic algorithms have been used in video analytic industry due to abundance of video frames or images from the unlabeled data.

However, to achieve high accuracy of video analytics, considerable amount of data needs to be annotated in order to train video analytic algorithms. If annotated by humans, cost of the data annotation may become prohibitively high. Particularly, in some specific applications, experts with professional knowledge are required to annotate correctly. For example, a known customized Person-Of-Interest (POI) system where machine learning as adopted for video analytics is severely limited in practice due to a number of issues. Firstly, low processing speeds of large neural networks causes unacceptable delays; Secondly, lack of labelled data for training the neural networks impairs machine learning; Thirdly, algorithms of the machine learning are sensitive to change of external factors, such as illumination, backlight condition, change in human pose and viewing angle especially for outdoor scenarios. Therefore, lack of sufficient amount of labeled data under various external factors become a bottle neck of developing a video analytics engine or algorithm. Accordingly, the subject application aims to develop a new and useful annotation method, device or system for a neural network. Essential features of relevant inventions are provided by one or more independent claims, whilst advantageous features of these inventions are presented by their corresponding dependent claims respectively.

As a first aspect, the present application discloses an annotation method for a neural network such as a deep learning model. The neural network of the annotation method is used for annotating or associating meta-data such as author, release time and description with a video content. A video clip with the video contest is thus searchable with one or more keywords as a query using a search engine. The neural network of the annotation method needs to be firstly trained, then tested and then becomes applicable for automatic annotation with high and reliable accuracy. Labeled instances are particularly needed for training the neural network. However, the labeled instances are expensive to obtain and limited in quantity, in contrast to unlabeled instances that are cheaply available with bountifulness.

The annotation method for a neural network may comprise a first step of receiving unlabeled instances (called or known as a first set of unlabeled instances) as information (such as photo images or video clips) from one or more sources; a second step of obtaining a learning target of the unlabeled instances; a third step of getting selected unlabeled instances (i.e. selecting a second set of unlabeled instances from the first set of the unlabeled instances) by executing a software algorithm; and a fourth step of acquiring annotation of the selected unlabeled instances for generating labeled instances or labeled data. The labeled data are used for training the neural network such as the deep learning model for automatic annotation. The selected unlabeled instances are chosen into the second set since the selected unlabeled instances have more weights in training the neural network. Specifically, the software algorithm is configured to combine, combines, or integrates semi-supervised learning and transfer learning for reducing necessary, minimum or required quantity, amount, or volume of the selected unlabeled instances as compared to quantity, amount or volume otherwise required.

The annotation method of the subject application has a major advantage of enhancing efficiency of annotation by requiring annotation the selected unlabeled instances (i.e. the second set of the unlabeled instances) during training. The first set comprises a first quantity or amount of the unlabeled instances; while the second set comprises a second quantity or amount of the selected unlabeled instances. Generally, the first quantity is so huge that the unlabeled instances of the first set cannot be annotated by an existing oracle, such as a human annotator. The second quantity is significantly less than the first quantity such that workload of annotation for the oracle is greatly reduced.

According to a specific application, the source may be a natural-image dataset, a geospatial dataset, an artificial dataset, facial dataset, video dataset, or a test dataset. For example, the source is combined with computer vision technologies for object detection, multiple object tracking, image registration and alignment, content-based image retrieval, person re-identification, attribute classification for a person-of-interest (POI) system or a vehicle-of-interest (VOI) system. The source may be a readily available dataset stored in a local computing device (such as a personal computer, a mainframe computer, a laptop computer, a tablet computer, a desktop computer); stored in a platform comprising one or more computing devices (such as a rackmount server, a router computer, a server computer, a personal computer, a mainframe computer, a laptop computer, a tablet computer, a desktop computer, etc.), data sources (e.g., hard disks, memories, databases), networks, and/or software components; or even a raw dataset collected in real time. The source may also be a type of private dataset or public dataset available regionally or globally.

The learning target is then set also according to a specific application. The learning target can be in a semantic format, a non-semantic format or a combination of the semantic format and the non-semantic format. For example, semantic features of a person may be a description of age, body shape, gender or hairstyle; while non-semantic features may be an image or a video clip for the POI system. For another example, sematic features of a vehicle may be a description of model, brand or license plate; while non-semantic feature may be an image or a video clip for the VOI system.

The unlabeled instances of the second set are selected from the first set by the software algorithm. As a result, the second set has a second volume that is much smaller than the first volume of the first set; and thus the unlabeled instances of the second set can be annotated by the existing oracle as labeled instances. For example, the first set has 5.5 million video frames or images, the software algorithm only selects around 8,500 video frames or images into the second set. The 8,500 video frames or images only needs one person for two days to annotate. The labeled instances are necessary for training the neural network, particularly the deep learning model such as a supervised model or a semi-supervised deep learning model. The deep learning model is especially useful in some specific fields such as deep learning based video analytics, where images or video clips of a person can be taken in relation to many factors such as under different poses, from different angles and heights, during different times of a same day, and indoor or outdoor. If one or more of the factors change, the appearance of the person on the images or in the video clips significantly changes accordingly. Therefore, the deep learning model (e.g. the supervised model or the semi-supervised model) needs to be trained to detect, track and recognize different intra-class variations generated by changes of the factors by using the labeled instances.

In particularly, the software algorithm of the annotation method combines semi-supervised learning and transfer learning for effectively selecting the unlabeled instances of the second set from the first set. Since only the unlabeled instances of the second set are annotated, the efficiency of annotation is greatly enhanced. Meanwhile, the unlabeled instances of the second set have more weights than the unlabeled instances that are not selected; and thus the deep learning model is not substantially affected if only the unlabeled instance of the second set are annotated and used for training the neural network. The semi-supervised learning utilizes both labeled instances and unlabeled instances for training. The transfer learning comprises a set of related but different learning tasks by generalizing a commonality of the learning tasks to the learning target. Therefore, the software algorithm can be universally used in many applications without further modification.

The third step of getting selected the second set of unlabeled data is optionally operated by firstly calculating a prediction value for each unlabeled instance of the first set; secondly determining a variance of the prediction value; and finally selecting the unlabeled instance for annotation when the variance of the prediction is greater than a first threshold value. In other words, the unlabeled instance is considered valuable for annotation only if the unlabeled instance has a higher uncertainty in predication.

The annotation method may further comprise a step of gaining, approving, or checking validation of the labelled instances. A third set of unlabeled instances may be further selected from the second set. The selection is conducted the same as selecting the unlabeled instances of the second set. Similarly, each of the unlabeled instances of the third set has a variance greater than a second threshold value. The second threshold value is even greater than the first threshold value. The unlabeled instances of the third set are annotated as labeled instances by the oracle and then used for training the neural network. Since the third set has a third volume smaller than the second volume of the second set, the efficiency of annotation is further enhanced.

If the neural network comprises a semi-supervised model, the remaining unlabeled instances are still used for training after the semi-supervised model is trained by the labeled instances of the third set. Outputs of the remaining unlabeled instances of the second set is validated or checked by the oracle. In particular, if the human annotator in involved, the validating process is also known as a human-in-the-loop approach. Since validating or checking annotations is faster than annotating per se, the semi-supervised model has a higher efficiency than that of the supervised model for the neural model.

The software algorithm of the annotation method optionally comprises an active deep learning model by asking queries in relation to the second set of unlabeled instances. In the active deep learning model (also known as active deep learner), the soft algorithm is allowed to further proactively select a sub-set of unlabeled instance from the second set according to a specific query. The sub-set is selected according to a similarity ranking in relation to the learning target contained in the unlabeled instances. The more similar the learning target is, the more likely the unlabeled instances are selected. The active deep learning model is constructed on a belief that the software algorithm could potentially achieve a better accuracy while using fewer unlabeled instances for training if the software algorithm was allowed to choose the unlabeled instances it prefers to learn from. The software algorithm in the active deep learning model is also allowed to pose queries during the training. The queries may be selected for several rounds; and the queries become more and more difficult for the oracle such as the human annotator to label. In this way, the software algorithm may achieve a high accuracy by using as few labelled instances as possible, thereby minimizing the cost of obtaining the labelled data.

Alternatively, a sequential model or a random model are used for sampling and labeling to evaluate an accuracy of annotation. However, both of the sequential model and the random model show a worse property of precision-recall compared with the active deep learning model. In other words, the active deep learning model requires less labeled instances than the sequential model or the random model for achieving a same accuracy. For example, the sequential model or the random model needs around 800,000 unlabeled instances that takes 800 man/hours to label. In contrast, the active deep learning model only needs around 30,000 unlabeled instances. Therefore, the active deep learning model improves the efficiency of annotation by around 27 times.

The software algorithm is tested after training for identifying whether the unlabeled instances are annotated correctly and properly. The testing process is a compulsory requirement for the semi-supervised model. The unlabeled instances may be picked up from either the first set or the second set. If the testing process fails, parameters of the software algorithm need to be adjusted or even re-set. For example, the image or the video frame may be represented by a volume of pixels in a two-dimensional space (x, y) as spatial coordinates; while the video clip may be represented by a volume of pixels in a three-dimensional space (x, y, t) as spatial coordinates and a temporal axis. The spatial coordinates and the temporal axis are used as parameters of the software algorithm for the for the image or the video frame.

The software algorithm optically comprises an augmentation means for randomly perturbing the second set of unlabeled instances. Since the learning target is influenced by many factors, the augmentation means purposely perturb each unlabeled instance of the second set by adjusting the factors to the unlabeled instance. As a result, the second volume of the second set significantly increases by multiplying a number of the factors to the second volume of the second set. The augmentation means solve a potential problem of overfitting when the second volume of the second set is not enough for training the neural network, particularly the deep learning model. The problem of overfitting is raised by treating training data too well since the deep learning model learns details and even noises that negatively impacts performance of the deep learning model. Therefore, the problem of overfitting can be cured by providing enough training data to the deep learning model, i.e. increasing the second volume of the second set. In addition, the software algorithm may also adept the deep learning model to various conditions where the factors change.

The software algorithm is coded in C++ language, python language or a combination of thereof. As a result, the software algorithm may be executed or run universally on any operational platform without being rewritten. The operational platform may be traditional Windows Platform, Universal Windows Platform (UWP), or mobile platforms such as Android, iOS, Hongmeng or Window Mobile.

The software algorithm is executed by one or more Graphic Processing Units (GPU), such as NVIDIA DGX-1 supercomputer or NVIDIA DGX-II supercomputer that are specially designed for deep learning, artificial intelligence, and accelerated analytics. Both NVIDIA DGX-1 supercomputer and NVIDIA DGX-II supercomputer provide access to a popular deep learning frameworks, NVIDIA DIGITS™ deep learning training application, third-party accelerated solutions, the NVIDIA Deep Learning SDK (e.g. cuDNN, cuBLAS, NCCL), CUDA® toolkit, NVIDIA Docker and NVIDIA drivers. Therefore, the NVIDIA DGX-1 supercomputer and NVIDIA DGX-II supercomputer provide effortless productivity by removing a burden of continually optimizing the software algorithm and delivering a ready-to-use and optimized software stack. In particular, the software algorithm of the annotation method may greatly enhance accuracy and performance of video analytics.

The annotation method may further comprise firstly detecting the learning target from the information; secondly tracking the learning target from the information; and finally retrieving the learning target from the information. More advantageously, the learning target is retrieved under different conditions when externals factors change. For example, the person can still be detected, tracked and recognized when the video clip or the image is taken under different pose, from different angles and heights, during different times of a same day, and indoor or outdoor.

The learning target of the unlabeled instances may comprise searchable attributes, characters, objects, events or any combination of the foregoing targets; detectable illegal packing, intrusion, loitering, abandoned objects or any combination of the foregoing targets; recognizable words license plate, faces, vehicles, objects or any combination of the foregoing targets; and countable vehicles, people, objects and any combination of the foregoing targets. In addition, one or more of the foregoing targets may be searched, detected, recognized and/or counted individually, collectively or even simultaneously for a single purpose or multiple purposes. For example, in the POI and VOI system, a person and a vehicle the person uses are searched as the learning target; if the person illegally parks the vehicle, this action is detected by the POI and VOI system; the person is recognized by his or her face and the vehicle is also recognizable by its license plate; and appearances of the person and the vehicle are also counted in the POI and VOI system.

The software algorithm may comprise an input layer, an output layer and a hidden layer between the input layer and the output layer. The hidden layer further comprises at least one sub-layer. Number of the sub-layers is called depth of the software algorithm employing the deep learning model. Generally, the more complicated the learning target is, the more sub-layers the hidden layer needs to build, and the more complex the software algorithm may be accordingly. The software algorithm may further comprise a softmax layer after the output layer for normalizing outputs of the output layer for converting the outputs into probabilities. In addition, the software algorithm may also propagate backward to adjust the parameters of the software algorithm comprising the weights and biases initially put into the input layer.

The second set of unlabeled instances has a greater amount than a critical value; i.e. the second volume of the second set is larger than the critical value. The software algorithm has a better performance than a handcrafted algorithm only when the second volume is larger than the critical value. The critical value may vary and be determined by a specific application.

The software algorithm has a deep active residual learning framework operating:

```
for i = 1 ... k do
  Uᵢ = Select (θᵢ₋₁,U,b/k)
  U ← U − Uᵢ
  Lᵢ = Lᵢ₋₁ ∪ Annotate(θᵢ₋₁,Uᵢ)
  θᵢ ← argmin_{θ} F(θ, L ∪ Lᵢ)
end
```

The input comprises labeled dataset L, unlabeled dataset U, labelling budget b, number of iterations k, and Loss function F(θ,D). The output comprises extended labelled dataset Lₖ∪L, trained residual net parameters θₖ; L₀←Ø, θ₀←argmin_{θ}F(θ, L∪Lᵢ). In addition, the deep active residual learning framework provides a generic functionality that can be selectively changed by additional code, and thus the deep active residual learning framework can be adapted to various specific applications.

The software algorithm is run or operated on a principled platform for improving performance and accuracy. The principled platform adopts a coherent set of mathematical principles of probability theory, information theory and Bayesian decision theory. The coherent set of mathematical principles has a major advantage of keeping the software algorithm transparent, explainable and interpretable. Therefore, the software algorithm is better at quantifying uncertainties, in contrast to a conventional black-box approach of deep neural networks. The principled platform is optionally universally applicable in a plurality of industries, such as logistics, retail as well as surveillance.

The software algorithm is operable for a semantic query, a non-semantic query or a mixed query having both a sematic sub-query and a non-semantic sub-query. The semantic query such as a text of description is applicable when a picture of the object (such as the person for the POI system or the vehicle for the VOI system) is not available. For example, we may know the age group, gender, race, body shape and skin color of a subject of interest by the description of a victim. The victim may have seen the color and brand of the car but haven't got a picture of the suspect's car. This is the Semantic part of the Person of Interest system for which we need to relate images with its labels and semantic attributes. The non-semantic query allows a content-based query such as an image or an image sequence, and thus is also called content query. The mixed query is common to handle complex queries as well as helping to refine the results to find the person-of-interest (POI).

In particular, the software algorithm can extract fine sematic information from non-semantic information such as images or video clips. Therefore, the non-semantic information is converted to sematic information which is easier to be searched by a search engine.

As a second aspect, the present application discloses a non-transitory machine-readable storage medium storing instructions which when executed, cause one or more computing devices to perform operations. The operations may comprise a first step of receiving unlabeled instances (called a first set of unlabeled instances) as information (such as photo images or video clips) from one or more sources; a second step of obtaining a learning target of the unlabeled instances; a third step of getting selected unlabeled instances (i.e. selecting a second set of unlabeled instances from the first set of the unlabeled instances) by executing a software algorithm; and a fourth step of acquiring annotation of the selected unlabeled instances for generating labeled instances or labeled data. In particular, the deep learning model of the software algorithm is configured to combine, combines or integrates semi-supervised learning and transfer learning. The operations are in accordance with the annotation method for the neural network of the first aspect. The software algorithm is optionally executed on a mobile platform, such as Android, iOS, Hongmeng OS.

The computing devices may be personal computers (PCs), laptops, mobile phones, smart phones, tablet computers, netbook computers, etc. The non-transitory machine-readable storage medium (or known as computer-usable or computer readable medium) can be any apparatus that can contain, store, communicate, propagate, or transport the program for use by or in connection with the instruction execution system, apparatus, or device, such as floppy disks, optical disks, CD-ROMs, and magnetic disks, read-only memories (ROMs), random access memories (RAMs), EPROMs, EEPROMs, magnetic or optical cards, flash memories or any combination of the foregoing media coupled to a bus of the computing device. The operations are in accordance with the annotation method for the neural network in the first aspect.

The operation of getting selected unlabeled instances is conducted by firstly calculating a prediction value for each unlabeled instance of the first set; secondly determining a variance of the prediction; and finally selecting the unlabeled instance when the variance of the prediction value is greater than a threshold value. The operations are in accordance with the annotation method for the neural network of the first aspect.

The operations of the computing device may further comprise an augmentation means for randomly perturbing the second set of unlabeled data. The operations are in accordance with the annotation method for the neural network of the first aspect.

The operations of the computing device optionally comprise gaining, approving, or checking validation of the labelled instances.

The operations of the computing device optionally further comprises firstly detecting the learning target from the information; secondly tracking the learning target from the information; and finally retrieving the learning target from the information. The operations are in accordance with the annotation method for the neural network of the first aspect.

The learning target of the unlabeled instances optionally comprises searchable attributes, characters, objects, events or any combination of the foregoing objects; detectable illegal packing, intrusion, loitering, abandoned objects or any combination of the foregoing objects; recognizable words, license plate, faces, vehicles, objects or any combination of the foregoing objects; and/or countable vehicles, people, objects and any combination of the foregoing objects.

The software algorithm optionally comprises an input layer, an output layer and a hidden layer between the input layer and the output layer.

Similar to the first aspect, the quantity of the selected unlabeled instances is greater than a critical value.

The software algorithm may have a deep active residual learning framework operating:

```
for i =1 ... k do
  Uᵢ = Select (θᵢ₋₁,U,b/k)
  U ← U − Uᵢ
  Lᵢ = Lᵢ₋₁ ∪ Annotate(θᵢ₋₁,Uᵢ)
  θᵢ ← argmin_{θ} F(θ, L ∪ Lᵢ)
end
```

The input comprises labeled dataset L, unlabeled dataset U, labelling budget b, number of iterations k, and Loss function F(θ,D). The output comprises extended labelled dataset Lₖ∪L, trained residual net parameters θₖ; L₀←Ø; θ₀←argmin_{θ}F(θ, L∪Lᵢ). The software algorithm is stored in the non-transitory machine-readable storage medium and operable on the computing device. The operations are in accordance with the annotation method for the neural network of the first aspect.

Similar to the first aspect, the software algorithm may be configured to run on a principled platform for improving performance and accuracy.

The software algorithm is possible configured to a semantic query, a non-semantic query or a complex query having both a sematic sub-query and a non-semantic sub-query.

As a third aspect, the present application discloses a computer program product comprising a non-transitory machine-readable storage medium storing instructions which when executed, cause a computing device to perform operations comprising a first step of receiving unlabeled instances (called a first set of unlabeled instances) as information (such as photo images or video clips) from one or more sources; a second step of obtaining a learning target of the unlabeled instances; a third step of getting selected unlabeled instances (i.e. selecting a second set of unlabeled instances from the first set of the unlabeled instances) by executing a software algorithm; and a fourth step of acquiring annotation of the selected unlabeled instances for generating labeled instances or labeled data. The software algorithm is configuring to combine, combines or integrates semi-supervised learning and transfer learning. The operations are in accordance with the annotation method for the neural network of the first aspect or the second aspect.

The computer program product is accessible from the non-transitory machine-readable storage medium (also known as computer-usable or computer-readable storage medium) of the second aspect. The computer program product provides program code for use by or in connection with the computing device or any instruction execution system.

The software algorithm is optionally executed on a mobile platform, such as Android, IOS or Hongmeng OS.

Similar to the first aspect or the second aspect, the operations can further comprise gaining, approving, or checking validation of the labelled instances.

The selecting operation may be operated by firstly calculating a prediction value for each unlabeled instance of the first set; secondly determining a variance of the prediction; and finally selecting the unlabeled instance when the variance of the prediction value is greater than a threshold value. The operations are in accordance with the annotation method for the neural network of the first aspect and the non-transitory machine-readable storage medium of the second aspect.

The operations of the computing device may further comprise an augmentation means for randomly perturbing the second set of unlabeled data. The operations are in accordance with the annotation method for the neural network of the first aspect and the non-transitory machine-readable storage medium of the second aspect.

The operations of the computing device optionally further comprises firstly detecting the learning target from the information; secondly tracking the learning target from the information; and finally retrieving the learning target from the information. The operations are in accordance with the annotation method for the neural network of the first aspect and the non-transitory machine-readable storage medium of the second aspect.

The learning target of the unlabeled instances optionally comprises searchable attributes, characters, objects, events or any combination of the foregoing objects; detectable illegal packing, intrusion, loitering, abandoned objects or any combination of the foregoing objects; recognizable words, license plate, faces, vehicles, objects or any combination of the foregoing objects; and/or countable vehicles, people, objects and any combination of the foregoing objects.

The software algorithm sometimes comprises an input layer, an output layer and a hidden layer between the input layer and the output layer.

Similar to the first aspect or the second aspect, the quantity of the selected unlabeled instances may be greater than a critical value, a predetermined or a predetermined critical value.

The software algorithm can have a deep active residual learning framework operating:

```
for i =1 ... k do
  Uᵢ = Select (θᵢ₋₁,U,b/k)
  U ← U − Uᵢ
  Lᵢ = Lᵢ₋₁ ∪ Annotate(θᵢ₋₁,Uᵢ)
  θᵢ ← argmin_{θ} F(θ, L ∪ Lᵢ)
end
```

The input comprises labeled dataset L, unlabeled dataset U, labelling budget b, number of iterations k, and Loss function F(θ,D). The output comprises extended labelled dataset Lₖ∪L, trained residual net parameters θₖ; L₀←Ø; θ₀←argmin_{θ}F(θ, L∪Lᵢ). The software algorithm is stored in the non-transitory machine-readable storage medium and operable on the computing device. The operations are in accordance with the annotation method for the neural network of the first aspect and the non-transitory machine-readable storage medium of the second aspect.

The software algorithm may be configured to run on a principled platform for improving performance and accuracy. The software algorithm can further be configured to a semantic query, a non-semantic query or a complex query having both a sematic sub-query and a non-semantic sub-query.

As a fourth aspect, the present application discloses an annotation system (also known as platform) by adopting the annotation method of the first aspect. The annotation system comprises a memory and a processor operatively coupled to the memory. The memory is operable to firstly receive unlabeled instances (called a first set of unlabeled instances) as information (such as photo images or video clips) from one or more sources; secondly obtain a learning target of the unlabeled instances; thirdly get selected unlabeled instances (i.e. selecting a second set of unlabeled instances from the first set of the unlabeled instances) by executing a software algorithm; and finally acquire annotation of the selected unlabeled instances for generating labeled instances or labeled data. The software algorithm increases the efficiency of annotation in training neural networks for deep-learning-based video analysis by combining semi-supervised learning and transfer learning via a data augmentation method. The software algorithm can increase the efficiency of annotation by reducing an amount of annotation by an order of one magnitude.

The memory may comprise Read-Only Memory (ROM), flash memory, Dynamic Random Access Memory (DRAM) (e.g. Synchronous DRAM (SDRAM), Rambus DRAM (RDRAM)), static memory (e.g. flash memory, Static Random Access Memory (SRAM)), or any data storage device configured to communicate with a bus of the computing device. The memory may also comprise any combination of the foregoing types of memory.

The processor may comprise one or more general-purpose processing devices such as microprocessor, central processing unit, complex instruction set computing (CISC) microprocessor, reduced instruction set computing (RISC) microprocessor, very long instruction word (VLIW) microprocessor, or a processor implementing other instruction sets or processors implementing a combination of instruction sets. The processor may also comprise one or more special-purpose processing devices such as application specific integrated circuit (ASIC), field programmable gate array (FPGA), digital signal processor (DSP), network processor. The processor may comprise one or more general-purpose processing devices and one or more special-purpose processing devices.

The annotation system or platform optionally can provide an application programming interface (API) as an environment in which the software algorithm is executed. The API further comprises a set of subroutine definitions, communication protocols, and tools such as building blocks for developing the software algorithm. The API optionally provides specifications of various forms, such as routines, data structures, object classes, variables, or remote calls.

The selecting operation may be operated by firstly calculating a prediction value for each unlabeled instance of the first set; secondly determining a variance of the prediction; and finally selecting the unlabeled instance when the variance of the prediction value is greater than a threshold value. The operations are in accordance with the annotation method for the neural network of the first aspect, the non-transitory machine-readable storage medium of the second aspect and the computer program product of the third aspect.

The operations of the computing device may further comprise an augmentation means for randomly perturbing the second set of unlabeled data. The operations are in accordance with the annotation method for the neural network of the first aspect, the non-transitory machine-readable storage medium of the second aspect and the computer program product of the third aspect.

The software algorithm is optionally executed on a mobile platform, such as Android, iOS, or Hongmeng OS.

The processor is optionally operable to gain, approve, or check validation of the labelled instances.

The operations of the computing device optionally further comprises firstly detecting the learning target from the information; secondly tracking the learning target from the information; and finally retrieving the learning target from the information. The operations are in accordance with the annotation method for the neural network of the first aspect, the non-transitory machine-readable storage medium of the second aspect and the computer program product of the third aspect.

The learning target of the unlabeled instances optionally comprises searchable attributes, characters, objects, events or any combination of the foregoing objects; detectable illegal packing, intrusion, loitering, abandoned objects or any combination of the foregoing objects; recognizable words, license plate, faces, vehicles, objects or any combination of the foregoing objects; and/or countable vehicles, people, objects and any combination of the foregoing objects.

The software algorithm optionally comprises an input layer, an output layer and a hidden layer between the input layer and the output layer.

The quantity of the selected unlabeled instances can be greater than a critical value, a predetermined value or a predetermined critical value.

The software algorithm may have a deep active residual learning framework operating:

```
for i =1 ... k do
  Uᵢ = Select (θᵢ₋₁,U,b/k)
  U ← U − Uᵢ
  Lᵢ = Lᵢ₋₁ ∪ Annotate(θᵢ₋₁,Uᵢ)
  θᵢ ← argmin_{θ} F(θ, L ∪ Lᵢ)
end
```

The input comprises labeled dataset L, unlabeled dataset U, labelling budget b, number of iterations k, and Loss function F(θ,D). The output comprises extended labelled dataset Lₖ∪L, trained residual net parameters θₖ; L₀←Ø; θ₀←argmin_{θ}F(θ, L∪Lᵢ). The software algorithm is stored in the non-transitory machine-readable storage medium and operable on the computing device. The operations are in accordance with the annotation method for the neural network of the first aspect, the non-transitory machine-readable storage medium of the second aspect and the computer program product of the third aspect.

The software algorithm is possibly configured to run on a principled platform for improving performance and accuracy.

The software algorithm is sometimes configured to a semantic query, a non-semantic query or a complex query having both a sematic sub-query and a non-semantic sub-query.

The accompanying figures (Figs.) illustrate embodiments and serve to explain principles of the disclosed embodiments. It is to be understood, however, that these figures are presented for purposes of illustration only, and not for defining limits of relevant applications.

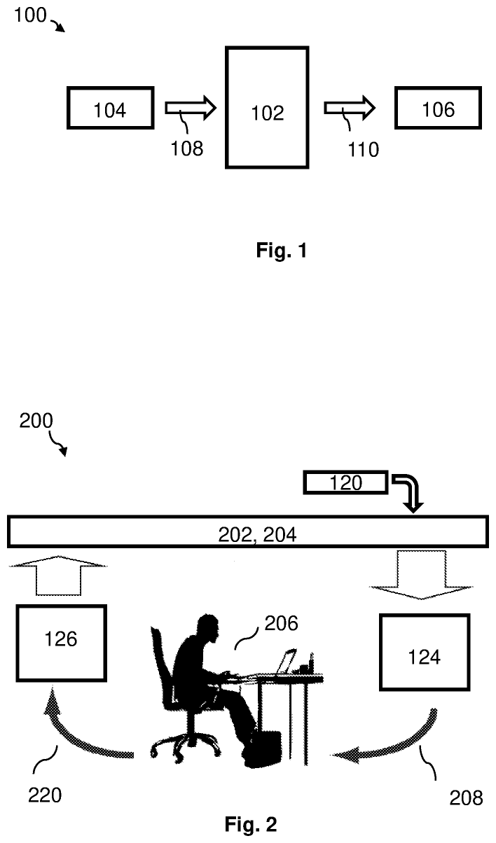

FIG. 1 illustrates an overall system architecture comprising an annotation system.

FIG. 2 illustrates a first embodiment of the annotation system wherein a software algorithm comprises a basic active deep learning model.

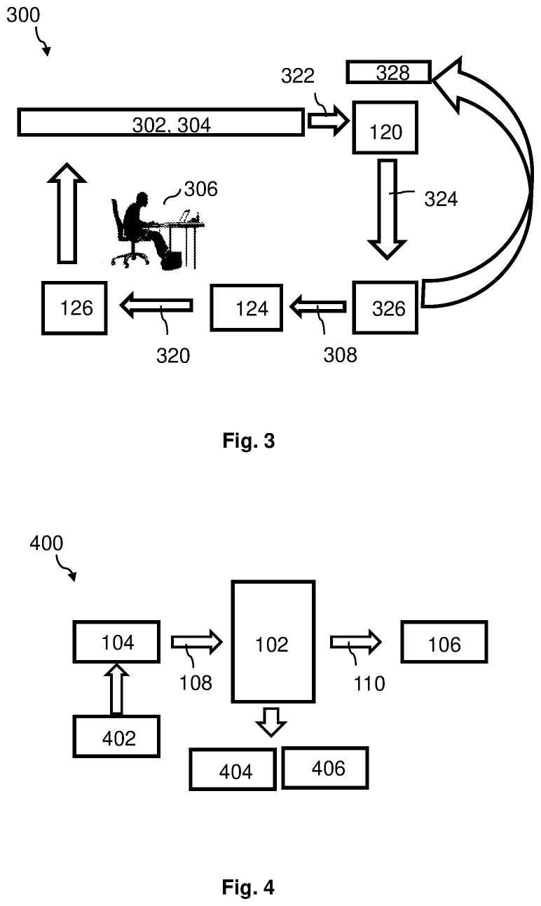

FIG. 3 illustrates a second embodiment of the annotation system wherein a software algorithm comprises a content-based active deep learning model.

FIG. 4 illustrates a person-of-interest (POI) scheme using the second embodiment of the annotation system.

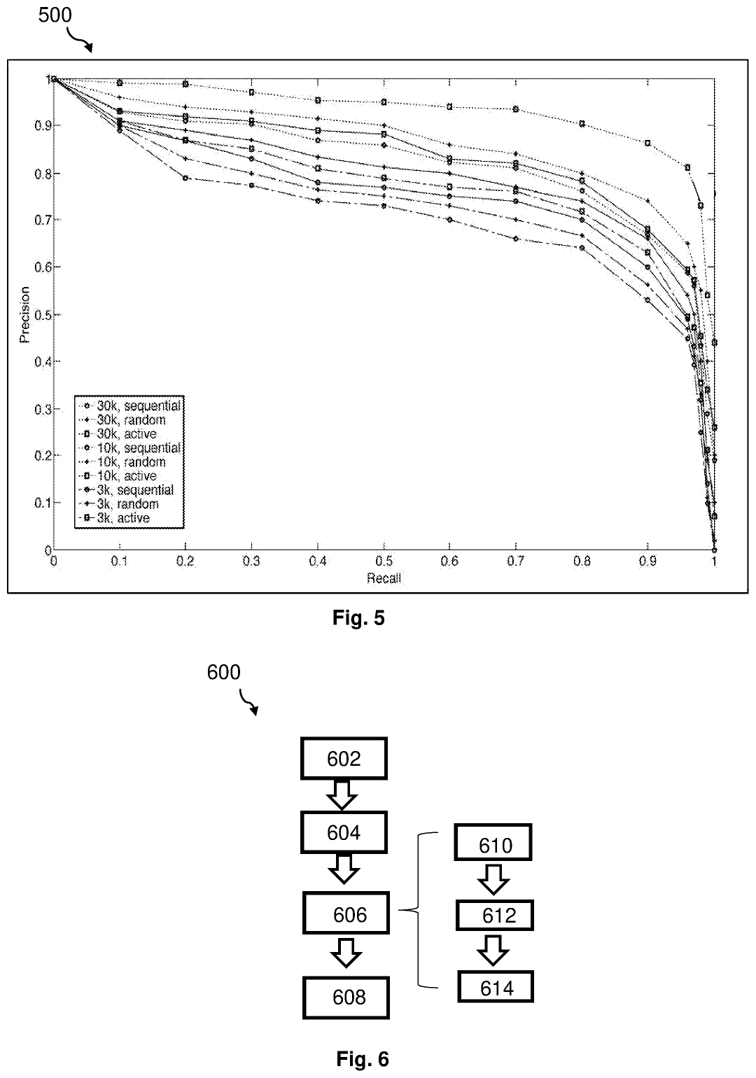

FIG. 5 is a diagram illustrating three sample selection and labelling methods.

FIG. 6 illustrates an operation flow of an annotation method of the annotation system.

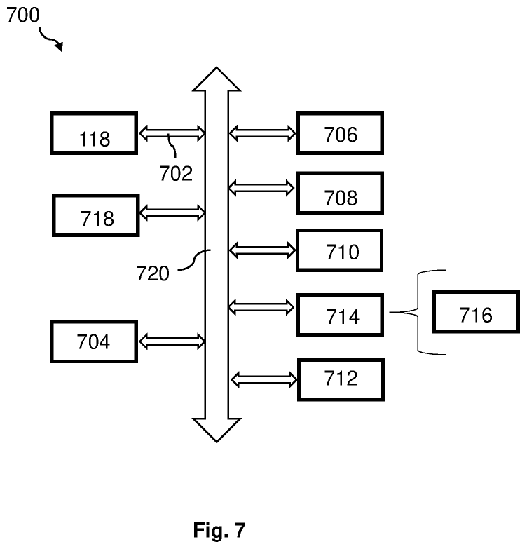

FIG. 7 illustrates an operation flow of a computer arrangement.

FIG. 1 illustrates an overall system architecture 100 comprising an annotation system 102. The overall architecture 100 further comprises one or more data sources 104 and one or more client devices 106. The data source 104 is configured to be connected to the annotation system 102 via a first network 108; and the annotation system 102 is also configured to be connected to the client device 106 via a second network 110.

The data source 104 may collect data in real time such that the data are communicated to the annotation system without delay. Alternatively, the data source 106 may comprise a store memory 112 for storing the collected data. The store memory 112 may be a computing memory (e.g., random access memory), a cache, a drive (e.g., a hard drive), a flash drive, a database system, or another type of component or device capable of storing data.

In particular, the data source 104 may be repositories of video contents when the annotation system 102 is used for video analytics. The data source 104 may comprise multiple storage components (e.g., multiple drives or multiple databases) that may also span multiple computing devices (e.g., multiple server computers).

The client device 106 may comprise one or more computing devices such as personal computers (PCs), laptops, mobile phones, smart phones, tablet computers, netbook computers, etc. The client device 106 may further comprise a media viewer 114. The media viewer 114 allows users to view contents, such as images, videos, web pages, documents, etc. For example, the media viewer 114 may be a web browser that can access, retrieve, present, and/or navigate content (e.g., web pages such as Hyper Text Markup Language (HTML) pages, digital media items, etc.) served by a web server. The media viewer 114 may render, display, and/or present the content (e.g., a web page, a media viewer) to a user. The media viewer 114 may also display an embedded media player (e.g., a Flash® player or an HTML5 player) that is embedded in a web page (e.g., a web page that may provide information about a product sold by an online merchant). Alternatively, the media viewer 114 may be a standalone application (e.g., a mobile app) that allows users to view digital media items (e.g., digital videos, digital images, electronic books, etc.).

The networks 108, 110 may comprises a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

The annotation system 102 comprises an annotation memory 116 and a processor 118 operatively coupled to the annotation memory 116. In particularly, the annotation memory 116 comprises a non-transitory machine-readable storage medium where a series of instructions are stored for causing the process 118 to perform operations. The processor 118 is instructed to firstly receive information comprising a first set 120 of unlabeled instances (such as video contents) from the data source 104; secondly set a learning target 122 of the information; thirdly select a second set 124 of unlabeled instances from the first set 122 of unlabeled instances by executing a software algorithm 124; and finally annotate the second set 124 of unlabeled instances for generating a third set 126 of labeled instances. The software algorithm 124 combines semi-supervised learning 128 and transfer learning 130.

In particular, when used for video analytics, the annotation system 102 converts raw video contents (e.g., contents stored in data source 104) into annotated video content to facilitate video classification, video searching, advertisement targeting, spam and abuse detection, content rating, etc.

The data source 104 may collect personal information, such as information about a person's social network, social actions or activities, profession, preferences, or current location. The annotation system 102 may control whether to receive and how to receive the personal information. Alternatively, personal information may be treated in one or more ways before it is stored in the data source 104 or used in the annotation system 102, so that personally identification is removed. For example, a person's identity may be treated so that no personally identifiable information can be determined for the person, or a person's geographic location may be generalized where location information is obtained (such as to a city, ZIP code, or state level), so that a particular location of the person cannot be determined.

FIG. 2 and FIG. 3 illustrate embodiments of the annotation system 102. FIG. 2 illustrates a first embodiment 200 comprising a first software algorithm 202, a basic active deep learning model 204 and a human oracle 206. The basic active deep learning model 202 is universally applicable to various learning targets 122 and thus the first embodiment 200 of the annotation system 102 may achieve goods performance in almost all scenarios. In other words, the first embodiment 200 may annotate sematic queries, non-sematic queries or complex queries having both sematic queries and non-semantic queries.

The first set 120 of unlabeled instances from the data source 104 (not shown) is communicated to the first software algorithm 202. The first software algorithm 202 selects out the second set 124 of the unlabeled instances according to a specific application such as video analytics. Then the basic active deep learning model 204 ask one or more rounds of queries 208 for the human annotator 206 to label. If two or more rounds of queries 208 are asked, the queries 208 may become more and more difficult for the human annotator 206 since the basic active deep learning model 204 learns progressively through the rounds of queries 208. The second set 124 of unlabeled instances are thus converted to the third set 126 of labeled instances 220 that are further fed to the basic active deep learning model 204. The unlabeled instances of the first set 120 that are not selected are also used for training the basic active deep learning model 204 for a semi-supervised learning method.

The selection of the second set 124 is performed by firstly calculating a prediction value 210 for each unlabeled instance of the first set 120; secondly determining a variance 212 of the prediction value 210; and finally selecting the unlabeled instance for annotation when the variance 212 of the prediction value 210 is greater than a first threshold value 214. The selection of the second set 124 significantly reduces the unlabeled instances to be labeled and thus solves a long-stand issue of slow processing speed for large networks of the annotation system 102.

In addition, the unlabeled instances of the second set 124 may be perturbed by an augmentation means 218 before annotation if the second set 124 does not have enough unlabeled instances. The augmentation means 216 purposely perturbs each unlabeled instance of the second set 124 and generates a number of different aspects of the unlabeled instances. The number of different aspects is called a factor 218 of the unlabeled instance that is determined by nature of the learning target 122. For example, if the learning target 122 is an automobile as the unlabeled instance, images or video clips of the automobile is perturbed from a front side, a left side, a right side, a back side and a top side. As a result, the augmentation means 216 generates five (05) different aspects of the automobile. Therefore, the second set 124 significantly increases in volume by multiplying the factor 218 for solving a potential problem of overfitting for the basic active deep learning model 204.

FIG. 3 illustrates a second embodiment 300 comprising a second software algorithm 302, a content-based active deep learning model 304 and a human oracle 306. The second software algorithm 302 is specially designed for non-semantic queries or content queries; and thus the second embodiment 300 has different operation from the first embodiment 200.

Unlabeled instances such as images or video frames are collected and communicated to the second software algorithm 302. The second software algorithm 302 performs inference 322 to pool the unlabeled instances into the first set 120. The unlabeled instances of the first set 120 are arranged according to similarity ranking 324 in terms of relevance. Relevant images or video frames 236 are thus obtained as outputs of the similarity ranking 324. In addition, the relevant images or video frames 326 are refined as refined relevant images or video frames 328 when the unlabeled instances have poor quantities or other issues that lead the relevant images 326 not suitable for subsequent operations.

Similar with first embodiment 200, the relevant images or video frames 326 are also selected into the second set 124 of the unlabeled instances by firstly calculating a prediction value 310 for each relevant image or video frames 326 as an unlabeled instance; secondly determining a variance 312 of the prediction value 310; and finally selecting the relevant image or video frames 326 for annotation when the variance 312 of the prediction value 310 is greater than a second threshold value 314.

Then the content-based active deep learning model 304 ask one or more rounds of queries 308 for the human annotator 306 to label the relevant images 326. The second set 124 of unlabeled instances are thus converted to the third set 126 of labeled instances 320 that are further fed to the content-based active deep learning model 304. The unlabeled instances of the first set 120 that are not selected are also used for training the content-based active deep learning model 304 for a semi-supervised learning method.

Similar to the first embodiment 200, the unlabeled instances of the second set 124 may be perturbed by an augmentation means 318 before annotation if the second set 124 does not have enough unlabeled instances.

The second embodiment 300 may be applicable to various industries. In other words, the learning target 122 of the second embodiment 200 may comprise searchable attributes, characters, objects, events or any combination of the foregoing targets; detectable illegal packing, intrusion, loitering, abandoned objects or any combination of the foregoing targets; recognizable words license plate, faces, vehicles, objects or any combination of the foregoing targets; and countable vehicles, people, objects and any combination of the foregoing targets. In addition, one or more of the foregoing targets may be searched, detected, recognized and/or counted individually, collectively or even simultaneously for a single purpose or multiple purposes.

FIG. 4 illustrate an application of the second embodiment 300, i.e. a person-of-interest (POI) scheme 400. The POI scheme 400 is a conceptual artificial intellectual (AI)-based search and recommendation engine that can provide users with all relevant information about the “person-of-interest”. The search and recommendation engine is done by simply a search query which may be text, voice as well as images or video clips.

The POI scheme 400 comprises the first embodiment 200 or the second embodiment 300 of the annotation system 102 and a computer vision system 402. The computer vision system 402 may gain high-level understanding from digital images or video clips. Thus, the computer vision system 402 may be applicable for various tasks, including acquiring, processing, analyzing and understanding of digital images, and extraction of high-dimensional data from a real world in order to produce numerical or symbolic information.

The annotation system 102 of the POI scheme 400 comprises a semantic query unit 404 for processing semantic queries and a non-semantic query unit 406 for processing non-semantic queries. For example, the semantic queries may be texts of description when pictures of a person are not available. The description may comprise age group, gender, race, body shape and skin color of the person. The non-semantic queries may be images or video clips of the person. In addition, the sematic query unit 404 and the non-semantic query unit 406 may work in conjunction to process complex queries and also help refine outputs of the POI scheme 400.

In particularly, the semantic query unit 404 of the annotation system 102 can extract fine semantic information from non-semantic information such as images and video clips. The non-semantic information could be age, gender hairstyle, fashion items (e.g. dresses, skirts, shirts) and attributes of the fashion items (e.g. color, pattern, shape, texture) of the person. The conversion of non-semantic information to semantic information is critical when a user search the person across surveillance video clips by using text inputs. The annotation system 102 is particularly useful in the security industry, where semantic indexing for a long term video clip provides time dependent structured information so that searches based on texts or descriptions become much more efficient than those based on video frames from the long term video clip.

However, some non-semantic information cannot be converted to semantic information by the semantic query unit 404. For example, if searching a person generates tens of thousands of retrieval results as images or video clips, the retrieval results are not likely to be converted to semantic results. The non-semantic query unit 406 is then used for content-based search and retrieval in a non-semantic way, i.e. searching images or video frames of the person directly by the non-semantic query unit 406. The non-semantic query is more efficient because an image or video frame contains much more information than the semantic query. For example, the POI scheme 400 can search over twenty thousand (20,000) surveillance cameras for one or more suspicious persons and return time and locations where the suspicious persons have appeared.

The basic active deep learning model 204 of the first embodiment 200 or the content-based active deep learning model 304 of the second embodiment 300 are adapted to various external factors, such as illumination, backlight condition, human pose and viewing angle. Thus the POI system 400 still functions well even if the appearance of a same person differs significantly due to any change of external factors. In other words, the POI scheme 400 provides a universal video analytics engine that can be used in different scenarios without customization and tuning.

The POI system 400 has a function of person retrieval and recognition and thus the POI system 400 may show paths that has been traveled by a person, locations where the person has appeared, an identity of the person, whom the person has interacted with, where the person has parked his or her car, whether the person exhibits an abnormal behavior and etc. Therefore, the POI scheme is extremely useful in a security and surveillance industry.

The POI scheme 400 of the present application has been applied to a range of analytics and show improved accuracies compared with current technologies. For example, the POI scheme 400 shows an accuracy of ninety-two percent (92%) out of ten thousand (10,000) POI tests; an accuracy of ninety-seven percent (97%) for face masking and an accuracy of ninety-four (94%) for people counting.

Similarly, a vehicle-of-interest (VOI) scheme can also be constructed and operated as the person-of-interest (POI) scheme 400 as described above. Various attributes of a vehicle such as model, brand, and even year of the vehicle can be searched by the sematic query unit 404 and the non-semantic query unit 406. The VOI scheme shows an accuracy of ninety-six percent (96%) for VOI.

FIG. 5 illustrates a diagram 500 of three sample selection and labelling methods, i.e. a traditional sequential selection and labeling method 502, a random sampling and labeling method 504 and an active learning based selectin and labeling method 506. The three selection and labeling methods 502, 504, 506 are extensively compared by sampling over an unlabeled human dataset of over 2.7 million including both positive and negative images of humans' upper-bodies.

FIG. 5 shows significant improvements in accuracy for the active learning based selection and labeling method 506. For a same number of labeled samples, the active learning based selection and labeling method 506 (denoted in squared curves) always has a higher precision-recall than the traditional sequential selection and labeling methods 502 (denoted in circled curves) and the random sampling and labeling method 504 (denoted in plus sign).

The active learning based selection and labeling method 506 also has a higher efficiency than the other two selections and labeling methods 502, 504. For example, in order to achieve a same accuracy, the selection and labeling methods 502, 504 roughly need around 800,000 samples that takes 800 man/hours to label. In contrast, the active learning based selection and labeling method 506 need only 30,000 samples which takes only 30 man/hours to label. Therefore, the active learning based selection and labeling method 506 improves the efficiency by around 27 times.

FIG. 6 illustrates an operation flow of an annotation method 600 of the annotation system 102. The annotation method 600 comprises a first step 602 of receiving information comprising a first set 120 of unlabeled instances such as video contents from one or more data sources 104; a second step 604 of setting a learning target 122 of the information; a third step 606 of selecting a second set 124 of unlabeled instances from the first set 124 of unlabeled instances by executing a software algorithm 202, 302; and a fourth step 608 of annotating the second set 124 of unlabeled instances for generating labeled instances 220, 320.

In particular, the third step 606 is optionally operated by a first procedure 610 of calculating a prediction value for each unlabeled instance of the first set 120; a second procedure 612 of determining a variance of the prediction value; and a third procedure 614 of selecting the unlabeled instance for annotation when the variance of the prediction is greater than a first threshold value.

FIG. 7 illustrates an operation flow of a computer arrangement 700. A set of instructions causes the computer arrangement to perform the annotation method 600. The computer arrangement 700 may be connected (e.g., networked) into a LAN, an intranet, an extranet, or the Internet. The computer arrangement 700 may operate in the capacity of a server or a client machine in client-server network environment, or as a peer machine in a peer-to-peer (or distributed) network environment. The computer arrangement 700 may be a personal computer (PC), a tablet PC, a set-top box (STB), a Personal Digital Assistant (PDA), a cellular telephone, a web appliance, a server, a network router, switch or bridge, or any machine capable of executing the set of instructions.

The computer arrangement 700 comprises a processor (processing device) 118, a main memory 704 (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage device 718, which communicate with each other via a bus 720.

The processor 118 represents one or more general-purpose processing devices such as a microprocessor, central processing unit, or the like. More particularly, the processor 118 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 118 may also be one or more special-purpose processing devices such as an application specific integrated circuit (ASIC), a field programmable gate array (FPGA), a digital signal processor (DSP), network processor, or the like. The processor 118 is configured to execute instructions 702 for performing the operations and steps discussed herein.

The computer arrangement 700 may further include a network interface device 704. The computer arrangement 700 also may comprises a video display unit 706 (e.g., a liquid crystal display (LCD), a cathode ray tube (CRT), or a touch screen), an alphanumeric input device 708 (e.g., a keyboard), a cursor control device 710 (e.g., a mouse), and a signal generation device 712 (e.g., a speaker).

A data storage device 714 may comprise a computer-readable storage medium 716 on which is stored one or more sets of instructions 702 (e.g., software) embodying any one or more of the methodologies or functions described herein (e.g., instructions of the annotation method 600). The instructions 702 may also reside, completely or at least partially, within a main memory 718 and/or within the processor 118 during execution thereof by the computer arrangement 700. The main memory 718 and the processor 118 also constitutes the computer-readable storage media 716. The instructions 702 may further be transmitted or received over a network via the network interface device 704.

While the computer-readable storage medium 716 is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

### REFERENCE NUMERALS

100 overall system architecture;
102 annotation system;
104 data source;
106 client device;
108 first network;
110 second network;
112 store memory;
114 media viewer;
116 annotation memory;
118 processor;
120 first set;
122 learning target;
124 second set;
126 third set;
128 semi-supervised learning;
130 transfer learning;
200 first embodiment;
202 first software algorithm;
204 basic active deep learning model;
206 human annotator;
208 queries;
210 prediction value;
212 variance;
214 first threshold;
216 augmentation means;
218 factor;
220 labeled instance;
300 second embodiment;
302 second software algorithm;
304 content-based active deep learning model;
306 human oracle;
308 queries;
310 prediction value;
312 variance;
314 second threshold;
316 augmentation means;
318 factor;
320 labeled instance;
322 inference;
324 similarity ranking;
326 relevant images (video frames);
328 refined relevant images (video frames);
400 person-of-interest (POI) scheme;
402 computer vision system;
404 semantic query unit;
406 non-sematic query unit;
500 diagram of sample selection and labelling methods;
502 traditional sequential selection and labeling method;
504 random sampling and labeling method;
506 active learning based selectin and labeling method;
600 annotation method;
602 first step;
604 second step;
606 third step;
608 fourth step;
610 first procedure;
612 second procedure;
614 third procedure;
700 computer arrangement;
702 instructions;
704 network interface device;
706 video display unit;
708 alphanumeric input device;
710 cursor control device;
712 signal generation device;
714 data storage device;
716 computer-readable storage medium;
718 main memory;
720 bus;

1. An annotation method for a neutral network, comprising:
receiving unlabeled instances as information from at least one source;
obtaining a learning target of the unlabeled instances;
getting selected unlabeled instances by executing a software algorithm; and
acquiring annotation of the selected unlabeled instances;
wherein the software algorithm is configured to combine semi-supervised learning and transfer learning for reducing quantity of the selected unlabeled instances.

2. The annotation method of claim 1, further comprising
gaining validation of the labelled instances.

3. The annotation method of claim 1, further comprising:
detecting the learning target from the information;
tracking the learning target from the information; and/or
retrieving the learning target from the information.

4. The annotation method of claim 1, wherein
the learning target of the unlabeled instances comprises
searchable attributes, characters, objects, events or any combination thereof;
detectable illegal packing, intrusion, loitering, abandoned objects or any combination thereof;
recognizable words, license plate, faces, vehicles, objects or any combination thereof; and/or
countable vehicles, people, objects and any combination thereof.

5. The annotation method of claim 1, wherein
the software algorithm comprises an input layer, an output layer and a hidden layer between the input layer and the output layer.

6. The annotation method of claim 1, wherein
the software algorithm has a deep active residual learning framework operating:
```
for i = 1 ... k do
  Uᵢ = Select (θᵢ₋₁,U,b/k)
  U ← U − Uᵢ
  Lᵢ = Lᵢ₋₁ ∪ Annotate(θᵢ₋₁,Uᵢ)
  θᵢ ← argmin_{θ} F(θ, L ∪ Lᵢ)
end
```

7. The annotation method of claim 1, wherein
the software algorithm is configured to a semantic query, a non-semantic query or a complex query having both a sematic sub-query and a non-semantic sub-query.

8. (canceled)

9. (canceled)

10. (canceled)

11. (canceled)

12. (canceled)

13. (canceled)

14. A computer program product comprising a non-transitory machine-readable storage medium storing instructions which when executed, cause at least one computing device to perform operations comprising:
receiving unlabeled instances as information from at least one source;
obtaining a learning target of the unlabeled instances;
getting selected unlabeled instances by executing a software algorithm; and
acquiring annotation of the selected unlabeled instances;
wherein the software algorithm is configured to combine semi-supervised learning and transfer learning for reducing quantity of the selected unlabeled instances.

15. The computer program product of claim 14, wherein
the operations further comprise gaining validation of the labelled instances.

16. The computer program product of claim 14, wherein
the quantity of the selected unlabeled instances is greater than a critical value.

17. The computer program product of claim 14, wherein
the software algorithm has a deep active residual learning framework operating:
```
for i =1 ... k do
  Uᵢ = Select (θᵢ₋₁,U,b/k)
  U ← U − Uᵢ
  Lᵢ = Lᵢ₋₁ ∪ Annotate(θᵢ₋₁,Uᵢ)
  θᵢ ← argmin_{θ} F(θ, L ∪ Lᵢ)
end
```

18. The computer program product of claim 14, wherein
the software algorithm is configured to run on a principled platform for improving performance and accuracy.

19. The computer program product of claim 14, wherein
the software algorithm is configured to a semantic query, a non-semantic query or a complex query having both a sematic sub-query and a non-semantic sub-query.

20. An annotation system comprising:
a memory; and
a processor operatively coupled to the memory, operable to:
receive unlabeled instances as information from at least one source;
obtain a learning target of the unlabeled instances;
get selected unlabeled instances by executing a software algorithm; and
acquire annotation of the selected unlabeled instances;
wherein the software algorithm is configured to combine semi-supervised learning and transfer learning for reducing quantity of the selected unlabeled instances.

21. The annotation system of claim 20, wherein
the software algorithm is executed on a mobile platform.

22. The annotation system of claim 20, wherein
the processor is further operable to gain validation of the labelled instances.

23. The annotation system of claim 20, wherein
the learning target of the unlabeled instances comprises
searchable attributes, characters, objects, events or any combination thereof;
detectable illegal packing, intrusion, loitering, abandoned objects or any combination thereof;
recognizable words, license plate, faces, vehicles, objects or any combination thereof; and/or
countable vehicles, people, objects and any combination thereof.

24. The annotation system of claim 20, wherein
the software algorithm has a deep active residual learning framework operating:
```
for i =1 ... k do
  Uᵢ = Select (θᵢ₋₁,U,b/k)
  U ← U − Uᵢ
  Lᵢ = Lᵢ₋₁ ∪ Annotate(θᵢ₋₁,Uᵢ)
  θᵢ ← argmin_{θ} F(θ, L ∪ Lᵢ)
end
```

25. The annotation system of claim 20, wherein
the software algorithm is configured to run on a principled platform for improving performance and accuracy.

26. The annotation system of claim 19, wherein
the non-semantic query comprises an image or a video clip for a person-of-interest (POI) system or a vehicle-of-interest (VOI) system.
